(19) United States
(12) Patent Application Publication
(10) Pub. No.: US 2024/0292812 A1
(43) Pub. Date: Sep. 5, 2024

(54) Animal training device

(71) Applicant: Evgeniia Kholod, Phuket (TH)

(72) Inventor: Evgeniia Kholod, Phuket (TH)

(21) Appl. No.: 18/116,309

(22) Filed: Mar. 2, 2023

(51) Int. Cl. A01K 15/02

(52) U.S. Cl. CPC A01K 15/022

(57) ABSTRACT

The present invention relates to advancement in a system and method of stopping the barking of dogs. The present system enables users to utilize smart devices to control the animal's behavior through a single click. The assembly involves three modes, including deterrent mode, ultrasonic training mode, and advanced flash plus ultrasonic mode, to control various types of dogs and their barking behaviors.

### COPYRIGHT NOTICE

A portion of this patent document's disclosure contains material subject to copyright protection. The copyright owner has no objection to the facsimile reproduction by anyone of the patent disclosure, as it appears in the Patent and Trademark Office patent files or records, but otherwise reserves all copyright rights.

### BACKGROUND

### Field of the Invention

This invention relates to the field of systems for controlling the barking of pet dogs. More specifically, the present invention relates to an anti-barking device that allows the training and management of dogs' behavior with NPS technology to grab the pet's attention and act as per the caretaker's instructions.

### Description of the Related Art

Nearly every owner of the 100 million dogs and cats in the United States would like their pet to be better trained but often can not afford to have it done, don't know how to do it themselves, or won't spend the time. Moreover, most pets, at least some of the time, have difficulty understanding what their trainers expect of them. As a result, the training process can be long and filled with errors.

Shocking devices of various kinds are well-known in animal training. For instance, cattle prods find use in navigating cattle traffic. Other shock devices are used to wean calves and train horses. U.S. Pat. No. 4,539,937 by Workman describes a horse training collar that delivers a controlled shock to the horse as its neck muscles expand during cribbing. U.S. Pat. No. 4,947,497 by Farkas describes a dog barking collar that produces a low shock at the onset of barking, which increases in intensity if the dog continues to bark to distinguish between “watchdog barking” and “nuisance barking.” The apparent drawback to electrical shock treatment is that it is often considered repugnant and cruel.

Negative audio stimuli have been used as a more humane alternative for animal training. Many dog collars have been designed to emit an unpleasant sound in response to a dog's undesirable behavior. For instance, the “PeaceMaker” (trademark) dog collar by Humane Technology, Inc.,

College Station, Tex. produces a single high-intensity sound burst with a decrescendo pattern shortly after detecting the dog's bark while ignoring extraneous sounds of brief duration. U.S. Pat. No. 4,180,013 to Smith describes a collar that responds to barking by emitting a high frequency noise and mechanically vibrating the dog's vocal cords. U.S. Pat. No. 5,061,918 to Hunter discloses a sound emitting collar that adjusts the sound intensity according to the previous behavior of the animal and also varies the sound pattern to avoid habituating the animal to the sounds.

Remote communication with animals is also known in the art-for example, U.S. Pat. No. 3,336,530 to Sloan et al. discloses a directional finding system for hunting dogs with a transmitter attached to a collar and a remote receiver, enabling the trainer to locate the dog. U.S. Pat. No. 3,589,337 to Doss discloses a collar that administers a dog shock in response to a remotely transmitted signal. U.S. Pat. No. 4,202,293 to Gonda et al. discloses a dog collar with a sound-emitting buzzer and shock terminals and a remote control that can activate the buzzer either alone or immediately followed by a light shock. U.S. Pat. No. 4,745,882 to Yarnall, Sr. et al. describes a device that administers a mild shock or unpleasant noise to a dog as it approaches the walls of a confined area. U.S. Pat. No. 4,766,847 to Venczel et al. also administers a shock to a dog as it comes to a predefined boundary but gradually increases the shock as the dog nears the boundary and continues the shock after the dog crosses the boundary. U.S. Pat. No. 4,967,696 to Tobias discloses a dog collar containing a receiver that emits a simple tone or a human voice upon being actuated by a remote transmitter. U.S. Pat. No. 5,054,428 to Farkus discloses a dog collar in which a remote transmitter can actuate to apply a short-duration shock to get the animal's attention and a more intense shock if the animal fails to conform to expected behavior.

The inherent disadvantage of the aforementioned prior art is that these devices provide only negative stimulation whereby the animal must either obey and respond appropriately or be punished. Positive feedback between the trainer and the animal is usually limited to voice and physical contact (petting), with neither being the primary training means. It should be appreciated, however, that basic training theory centers on the animal learning signals for “YES” and “NO.” These are most often taught through a series of rewards and punishments. Moreover, trainers often fail to effectively train their pets because they are inconsistent in the positive reinforcement (reward) and punishment they impose on the animal. For efficient and speedy training of animals, it is usually necessary to deliver a consistent and immediate negative stimulus (NO command) and a consistent and immediate positive stimulus (YES command).

Positive reinforcement devices which avoid resorting to injury or abuse are known in the field of animal training. U.S. Pat. No. 4,535,724 by David discloses a horse training apparatus mounted on a horse's neck, which includes a storage tank filled with a sweet liquid, a tube extending from the tank to the horse's mouth, a pump, a battery, and a switch so that a trainer or rider can press the switch to pump sweet liquid into the horse's mouth. In addition, a second identical set of equipment containing sour liquid can be mounted on the opposite side of the horse's neck so that the horse can be rewarded (sweet liquid) or punished (sour liquid). In the field of the dog barking, U.S. Pat. No. 4,335,682 to Gonda et al. describes a dog collar that produces a first sound at the commencement of a shock and a second sound when the shock is finished. A remote transmitter allows the user to generate the shock accompanied by the first sound when the shock begins and the second sound when the shock ends, as well as the first or second sound alone. In theory, the animal becomes conditioned to regard the first sound as a warning signal, and the second sound invokes feelings of safety, relief, and relaxation in the animal so that the trainer can later apply reward (second sound) and punishment (first sound) without the shock. A drawback to Gonda et al. is that shock is mandatory to condition the dog.

The use of auditory stimuli in animal learning and training dates from the classic works of Pavlov (1927) and Skinner (1938). See, for instance, I. P. Pavlov, Conditioned reflexes, London: Oxford University Press, 1927; and B. F. Skinner, Behavior of Organisms, New York: Appleton-Century-Crofts, 1938. In the subsequent years, auditory stimuli have been used as rewards, inhibitors, and discriminative stimuli in learning studies in various species, including dogs and cats.

Another point to consider is the consistency of the level of the punishment. Most owners find it difficult to be consistent when disciplining their pets. Usually, too much of the owner's state of mind gets in the way. Furthermore, by design, many of the previously discussed training devices administer inconsistent punishment. This inconsistency can confuse the animal and considerably lengthen training time.

Therefore, despite the availability of numerous positive reinforcement devices and punishment devices for behavior modification of animals, there is still a need for a humane training device that provides the consistent messages necessary to let the animal know when it is behaving correctly or incorrectly.

Multiple solutions have been presented in the prior art. However, these solutions are limited and restricted to their conventional architecture and installation system and have considerable shortcomings, adversely affecting the convenience of using them. The prior systems have certain limitations, including assemblies' design, which make them unsuitable for every type of user. Moreover, the ease-of-use ability of these assemblies is also questionable. The current invention proposes an advanced way of communication between owners and their pets. It stops the negative behavior and promotes positive behavior and communication between the trainer/owner and the pet. The current method for stopping the barking of dogs involves using a device that is easy to use by the trainer and doesn't cause any inconvenience to the pet.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following Summary is provided to facilitate an understanding of some of the innovative features unique to the present invention and is not intended to be a complete description. A full appreciation of the various aspects of the invention can be gained by taking the entire specification, claims, drawings, and abstract as a whole.

The present invention seeks to improve upon prior animal training devices and provide an enhanced system to perform the designated functionality.

Another object of the present invention is to provide a technological way of stopping the barking of animals by using a device with a method for teaching animals to communicate with humans using various signals.

The present invention's further objective is to provide an improved methodology allowing humans to use NPS technology to grab the pet's attention and control their behavior.

It is also the object of the invention to provide an easy-to-use process allowing to control dogs through sound mode, ultrasonic mode, and ultrasonic flashlight mode.

It is also the objective of the invention to provide an assembly that increases control and ease of use and enhances both the convenience and quality of the entire procedure.

It is also the objective of the invention to provide a whole methodology that is easy to use and adapt for people with minimal additional cost.

Thus, the objective is to provide a new and improved form of advancement in animal training methodologies. Other aspects, advantages, and novel features of the present invention will become apparent from the detailed description when considered in conjunction with the accompanying drawings.

This Summary is provided merely to summarize some example embodiments to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWINGS

The accompanying figures, where like reference numerals refer to identical or functionally similar elements throughout the separate views, together with the detailed description below, are incorporated in and form part of the specification, and serve to illustrate further embodiments of concepts that include the claimed invention and explain various principles and advantages of those embodiments.

FIG. 1 illustrates the complete view of the Dog Barking Control Device in accordance with an embodiment of the present disclosure.

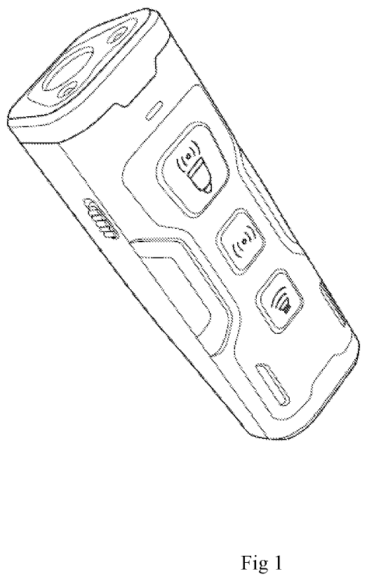

FIG. 2 illustrates multiple functional views of the Dog Barking Control Device per the embodiment of the present disclosure.

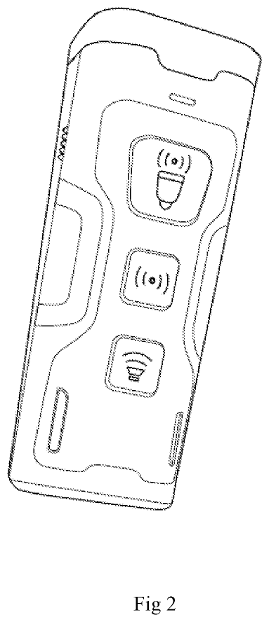

Skilled artisans will appreciate those elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. However, it is to be understood that the present invention may be embodied in various forms. Therefore, specific details disclosed herein are not to be interpreted as limiting but rather as a basis for the claims and as a representative basis for teaching one skilled in the art to employ the present invention in virtually any appropriately detailed system, structure, or manner.

The terminology used herein is to describe particular embodiments only and is not intended to be limiting to the invention. As used herein, “and/or” includes any and all combinations of one or more of the listed items. As used herein, the singular forms “a,” “an,” and “the” are intended to include the plural forms as well as the singular forms unless the context indicates otherwise. It will be further understood that the terms “comprises” and/or “comprising,” when used in this specification, specify the presence of stated features, steps, operations, elements, and/or components but do not preclude the presence or addition of one or more other features, steps, operations, parts, components, and/or groups thereof.

One aspect of the present invention, the current invention, discloses a method of using a device that aims at controlling the behavior of pets, mainly aimed at dogs.

The invention's preferred embodiment includes a housing enclosing battery and circuit board. Housing is generally a rectangular box having an upper portion and a lower portion, preferably releasably held together by a plurality of screws or bolts. The housing preferably has a bottom, top, and four side walls. LED lights are, in this embodiment, positioned in a linear arrangement on the front side, and a sonic emitter is placed in the center of the front side. Other housing shapes and configurations may be used in accordance with the invention.

As per its further embodiments, the assembly also includes an option for users to choose from various modes. The deterrent mode, or sound mode, allows the person to point the device toward the pet. The device beeps for 2-3 seconds with one button press. The user can show the device and can say a variety of instructions, including but not limited to “Sit,” “Stay,” or “Stop,” and press the button once. The user can hold the button down for a sustained effect.

As per its further embodiments, the assembly also includes a second mod, an ultrasonic mode designed for dogs that do not respond well to the sound mode. It emits an ultrasonic tone for 2-3 seconds with one button press. The operation starts user pointing the device toward the pet. Once the button is pressed, the device beeps for 2-3 seconds with one button press. The user can show the device and can say a variety of instructions, including but not limited to “Sit,” “Stay,” or “Stop,” and press the button once. The user can hold the button down for a sustained effect.

As per its further embodiments, the assembly also includes a second mode, a flashlight, and an ultrasonic mode, designed for dogs that do not respond well to the sound mode. This mode is also suitable in low-light areas. The operation starts user pointing the device toward the pet. Once the button is pressed, the device emits a flash of light with an ultrasonic tone. The device emits an ultrasonic tone for 2-3 seconds and rapidly flashes its light with one button. The user can show the device and can say a variety of instructions, including but not limited to “Sit,” “Stay,” or “Stop,” and press the button once. The device will flash, sound off and get the pet's attention. The user can hold the button down for a sustained effect.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the appended claims and their equivalents determine the content of this invention.

The Abstract of the Disclosure is provided to allow the reader to ascertain the technical disclosure's nature quickly. It is submitted with the understanding that it will not be used to interpret or limit the scope or meaning of the claims. In addition, in the foregoing Detailed Description, it can be seen that various features are grouped in various embodiments to streamline the disclosure. This method of disclosure is not to be interpreted as reflecting an intention that the claimed embodiments require more features than are expressly recited in each claim. Instead, as the following claims reflect, the inventive subject matter is less than all features of a disclosed embodiment. Thus, the following claims are incorporated into the Detailed Description, with each claim standing on its own as a separately claimed subject matter.

We claim:

1. A system and method to stop the barking of dogs using a smart device comprised:
a housing;
at least one sonic emitter carried by said housing and performing emission of ultrasonic sound waves;
at least one LED carried by said housing and performing a lighting function in a selected area when energized;
a battery power source carried by said housing selected to energize said at least one LED and inner circuit to provide desired functionality;
a deterrent mode;
an ultrasonic training mode; and, an advanced flash plus ultrasonic method.

2. The assembly, per claim 1, provides an indoor and outdoor training tool.

3. As per claim 1, the assembly provides a sound mode allowing control of the dog's behavior.

4. The assembly, per claim 1, provides an ultrasonic training mode allowing control of the dog's behavior previously not controlled by sound mode.

5. As per claim 1, the assembly provides an advanced flash plus ultrasonic training mode allowing control of the dog's behavior previously not controlled by sound mode.

6. The assembly as per claim 1, wherein the battery provides a long-lasting 32 Hour Battery life.

7. As per claim 1, the assembly combines auto shut-off hearing safety with an ultrasonic dog whistle to stop barking technology.
